(19) United States
(12) Patent Application Publication
(10) Pub. No.: US 2020/0367702 A1
(43) Pub. Date: Nov. 26, 2020

(54) Towel Drying Assembly

(71) Applicant: William Salisbury, Albuquerque, NM (US)

(72) Inventor: William Salisbury, Albuquerque, NM (US)

(21) Appl. No.: 16/419,786

(22) Filed: May 22, 2019

(51) Int. Cl. A47K 10/06; A47K 10/02

(52) U.S. Cl. CPC A47K 10/06; H05B 3/56; A47K 10/02

(57) ABSTRACT

A towel drying assembly for drying a wet towel or dish rag includes a housing that has a convex top thereby facilitating a towel to be draped over the housing. The housing has a plurality of apertures each extending into an interior of the housing. The plurality of apertures passes air therethrough thereby facilitating the towel to be in thermal communication with the interior of the housing when the towel is draped over the housing. A heating element is positioned within the housing such that the heating element is in thermal communication with the interior of the housing. The heating element heats the interior of the housing when the heating element is turned on. In this way the plurality of apertures can communicate heated air to the towel for drying the towel when the towel is draped over the housing.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to drying devices and more particularly pertains to a new drying device for drying a wet towel or dish rag.

### BRIEF SUMMARY OF THE INVENTION

An embodiment of the disclosure meets the needs presented above by generally comprising a housing that has a convex top thereby facilitating a towel to be draped over the housing. The housing has a plurality of apertures each extending into an interior of the housing. The plurality of apertures passes air therethrough thereby facilitating the towel to be in thermal communication with the interior of the housing when the towel is draped over the housing. A heating element is positioned within the housing such that the heating element is in thermal communication with the interior of the housing. The heating element heats the interior of the housing when the heating element is turned on. In this way the plurality of apertures can communicate heated air to the towel for drying the towel when the towel is draped over the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a towel drying assembly according to an embodiment of the disclosure.

FIG. 2 is a perspective in-use view of an embodiment of the disclosure.

FIG. 3 is a front view of an embodiment of the disclosure.

FIG. 4 is a bottom view of an embodiment of the disclosure.

FIG. 5 is a cross sectional view taken along line 5-5 of FIG. 4 of an embodiment of the disclosure.

### DETAILED DESCRIPTION OF THE INVENTION

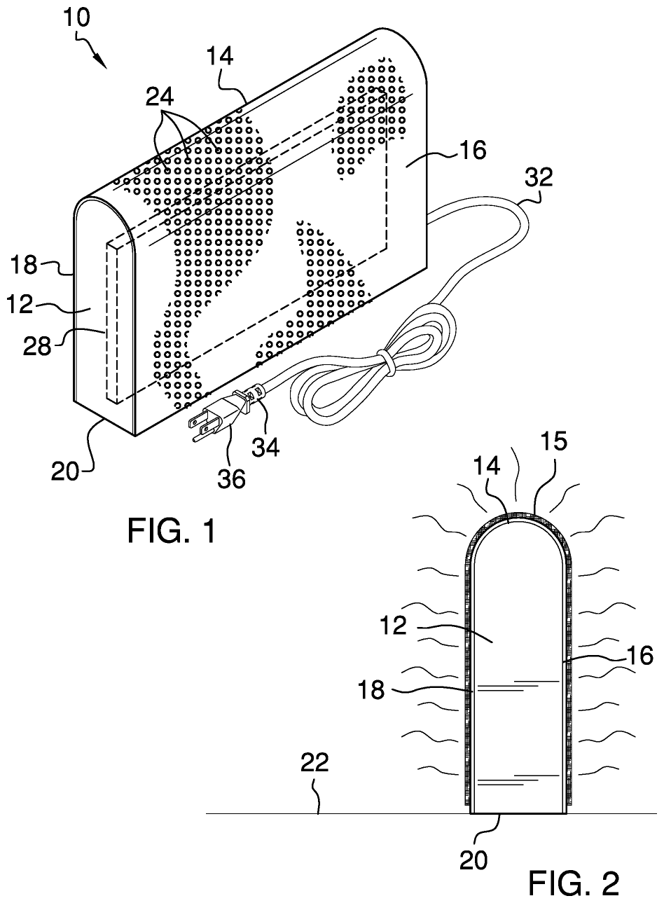

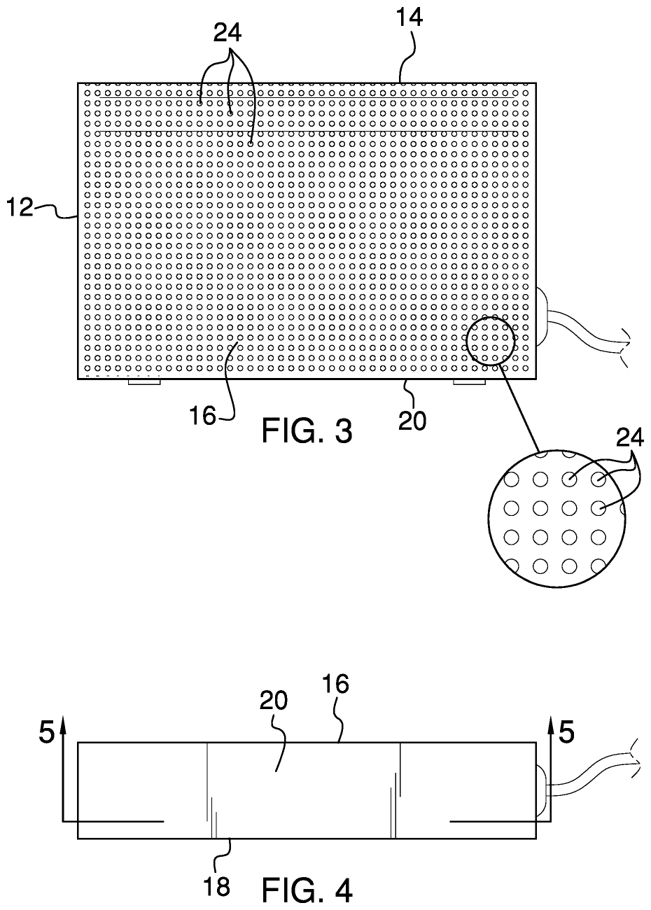

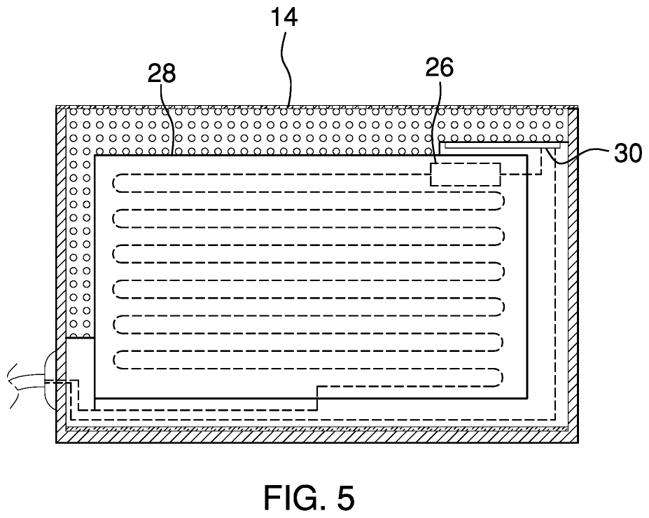

With reference now to the drawings, and in particular to FIGS. 1 through 5 thereof, a new drying device embodying the principles and concepts of an embodiment of the disclosure and generally designated by the reference numeral 10 will be described.

As best illustrated in FIGS. 1 through 5, the towel drying assembly 10 generally comprises a housing 12 has a convex top side 14. In this way a towel 15, such as a wet dish rag or the like, can be draped over the housing 12. The housing 12 has a front side 16, a back side 18, the top side 14 and a bottom side 20, and the bottom side 20 rests upon a support surface 22. The housing 12 may be positioned in a kitchen, near a kitchen sink, or other location where wet dish rags are commonly used. Additionally, the housing 12 may be produced in variety of colors to facilitate the housing 12 to match a variety of interior decors.

The top side 14 is convexly arcuate between the front 16 and back 18 sides and the housing 12 has a plurality of apertures 24 each extending into an interior of the housing 12. The plurality of apertures 24 passes air therethrough thereby facilitating the towel 15 to be in thermal communication with the interior of the housing 12 when the towel 15 is draped over the housing 12. Moreover, the apertures 24 are spaced apart from each other and are distributed on the front side 16, the back side 18 and the top side 14. The housing 12 may have a length of approximately 10.0 inches, a height of approximately 6.0 inches and a width of approximately 3.0 inches.

A control circuit 26 is positioned within the housing 12 and the control circuit 26 receives an on input and an off input. A heating element 28 is positioned within the housing 12 such that the heating element 28 is in thermal communication with the interior of the housing 12. The heating element 28 heats the interior of the housing 12 when the heating element 28 is turned on. Moreover, the plurality of apertures 24 communicates heated air to the towel 15 for drying the towel 15 when the towel 15 is draped over the housing 12. In this way a wet dish rag can be dried thereby inhibiting bacteria from growing on the wet dish rag and subsequently producing unpleasant odors.

The heating element 28 is electrically coupled to the control circuit 26. The heating element 28 is turned on when the control circuit 26 receives the on input. Additionally, the heating element 28 is turned off when the control circuit 26 receives the off input. The heating element 28 may comprise an electric heating coil or the like that has an operational temperature of approximately 100.0 degrees Fahrenheit.

A sensor 30 is coupled to the housing 12 and the sensor 30 senses when the towel 15 is positioned on the housing 12. The control circuit 26 receives the on input when the sensor 30 senses the towel 15. Additionally, the control circuit 26 receives the off input when the sensor 30 does not sense the towel 15. The sensor 30 may be an electronic light sensor 30 that senses light passing through the apertures 24. Moreover, the control circuit 26 may receive the on input when the towel 15 is draped over the housing 12, thereby inhibiting light from passing through the apertures 24.

A power cord 32 is coupled to and extends outwardly from the housing 12. The power cord 32 is electrically coupled to the control circuit 26. The power cord 32 has a distal end 34 with respect to the housing 12 and a male plug 36 is electrically coupled to the distal end 34. The male plug 36 can be electrically coupled to a power source comprising a female electrical outlet.

In use, the housing 12 is positioned on the support surface 22 and the power cord 32 is plugged into the power source. The heating element 28 is turned on when the towel 15 is draped over the housing 12. Thus, the heated air produced by the heating element 28 passes through the apertures 24 to dry the towel 15. In this way the towel 15 can be dried while the towel 15 is not being used, thereby inhibiting the towel 15 from developing foul odors. The heating element 28 is turned off when the towel 15 is removed from the housing 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A towel drying assembly being configured to have a wet towel placed thereon for drying the wet towel, said assembly comprising:
a housing having a convex top wherein said housing is configured to have a towel draped over said housing, said housing having a plurality of apertures each extending into an interior of said housing wherein said plurality of apertures is configured to pass air therethrough thereby facilitating the towel to be in thermal communication with said interior of said housing when the towel is draped over said housing; and
a heating element being positioned within said housing such that said heating element is in thermal communication with said interior of said housing, said heating element heating said interior of said housing when said heating element is turned on wherein said plurality of apertures is configured to communicate heated air to the towel for drying the towel when the towel is draped over said housing.

2. The assembly according to claim 1, wherein said housing has a front side, a back side, a top side and a bottom side, said bottom side resting upon a support surface, said top side being convexly arcuate between said front and back sides, said apertures being spaced apart from each other and being distributed on said front side, said back side and said top side.

3. The assembly according to claim 1, further comprising a control circuit being positioned within said housing, said control circuit receiving an on input and an off input.

4. The assembly according to claim 3, wherein said heating element is electrically coupled to said control circuit, said heating element being turned on when said control circuit receives said on input, said heating element being turned off when said control circuit receives said off input.

5. The assembly according to claim 4, further comprising a sensor being coupled to said housing wherein said sensor is configured to sense when the towel is positioned on said housing, said control circuit receiving said on input when said sensor senses the towel, said control circuit receiving said off input when said sensor does not sense the towel.

6. The assembly according to claim 5, further comprising a power cord being coupled to and extending outwardly from said housing, said power cord being electrically coupled to said control circuit, said power cord having a distal end with respect to said housing, said distal end having a male plug being electrically coupled thereto wherein said male plug is configured to be electrically coupled to a power source comprising a female electrical outlet.

7. A towel drying assembly being configured to have a wet towel placed thereon for drying the wet towel, said assembly comprising:
a housing having a convex top wherein said housing is configured to have a towel draped over said housing, said housing having a front side, a back side, a top side and a bottom side, said bottom side resting upon a support surface, said top side being convexly arcuate between said front and back sides, said housing having a plurality of apertures each extending into an interior of said housing wherein said plurality of apertures is configured to pass air therethrough thereby facilitating the towel to be in thermal communication with said interior of said housing when the towel is draped over said housing, said apertures being spaced apart from each other and being distributed on said front side, said back side and said top side;
a control circuit being positioned within said housing, said control circuit receiving an on input and an off input;
a heating element being positioned within said housing such that said heating element is in thermal communication with said interior of said housing, said heating element heating said interior of said housing when said heating element is turned on wherein said plurality of apertures is configured to communicate heated air to the towel for drying the towel when the towel is draped over said housing, said heating element being electrically coupled to said control circuit, said heating element being turned on when said control circuit receives said on input, said heating element being turned off when said control circuit receives said off input;
a sensor being coupled to said housing wherein said sensor is configured to sense when the towel is positioned on said housing, said control circuit receiving said on input when said sensor senses the towel, said control circuit receiving said off input when said sensor does not sense the towel; and
a power cord being coupled to and extending outwardly from said housing, said power cord being electrically coupled to said control circuit, said power cord having a distal end with respect to said housing, said distal end having a male plug being electrically coupled thereto wherein said male plug is configured to be electrically coupled to a power source comprising a female electrical outlet.

8. The assembly according to claim 7, wherein each of said top side, said front side and said back side of said housing is open.

9. The assembly according to claim 8, further comprising a mesh material being positioned over said back side, said top side and said front side of said housing wherein said mesh material is configured to pass air into said housing, said mesh material being convexly arcuate over said top side, said mesh material being comprised of a rigid material wherein said mesh material is configured to support the weight of the towel.
